(19) United States
(12) Patent Application Publication
(10) Pub. No.: US 2026/0056010 A1
(43) Pub. Date: Feb. 26, 2026

(54) PRINTING APPARATUS

(71) Applicant: CANON KABUSHIKI KAISHA, Tokyo (JP)

(72) Inventors: KEITA TAMIYA, Kanagawa (JP); KAZUYA TSUJINO, Tokyo (JP); CHIHIRO NAGURA, Tochigi (JP)

(21) Appl. No.: 19/295,911

(22) Filed: Aug. 11, 2025

(30) Foreign Application Priority Data
Aug. 23, 2024 (JP) 2024-143350

(51) Int. Cl. G01B 11/00; B41J 11/00; B41J 11/06

(52) U.S. Cl. CPC G01B 11/005; B41J 11/0095; B41J 11/06; B41J 11/0065

(57) ABSTRACT

A printing apparatus comprises a sensor unit including a light emitter, a light-receiving element array including a plurality of light-receiving elements that receive reflected light from a detection target, and an aperture member that is provided between the detection target and the light-receiving element array and has an opening. The apparatus obtains a positional relation between each of the light-receiving elements and the opening through which the reflected light passes, selects one or more light-receiving elements to be used for detecting an edge of a print medium in the detection target, as a first light-receiving unit and a second light-receiving unit, based on the positional relation, and detects the edge of the print medium based on a differential signal of signals from the first light-receiving unit and the second light-receiving unit.

### BACKGROUND

### Field of the Technology

The present disclosure relates to a printing apparatus.

### Description of the Related Art

When an inkjet printing apparatus performs borderless printing, there is an issue that low detection accuracy of an edge portion of a print medium such as a sheet leads to contamination inside the apparatus and formation of a unintended margin at an edge of a print medium. A general technique for detecting an edge portion of a print medium (hereinafter, a “medium edge portion”) in such a printing apparatus will be described below. A light-emitting element such as an LED and a light-receiving element such as a phototransistor that converts an optical signal into an electrical signal are used, reflected light obtained by the light-emitting element emitting light and a print medium reflecting the light is detected by the light-receiving element, and a medium edge portion of the print medium is detected based on a resultant detection signal. With this detection technique, the detection accuracy tends to decrease due to the influence of an environmental change such as contamination on a print medium.

Japanese Patent Laid-Open No. 16-182361 describes detection of a medium edge portion based on a detection signal from a light-receiving element when a detection target position of a media sensor is moved relative to a sheet, in an image forming apparatus provided with the media sensor that includes a light-emitting element and the light-receiving element. In addition, Japanese Patent Publication No. 6630121 describes a configuration in which, when an aperture stop is displaced from its ideal position, specular reflected light illuminating a light-receiving element array is also displaced, and thus, the displacement of the aperture stop is absorbed by sequentially measuring the light-receiving amounts of the light-receiving elements in the array, and changing an effective light-receiving element based on the measurement result.

Japanese Patent Laid-Open No. 16-182361 describes a method for detecting a medium edge portion using one light-emitting element and one light-receiving element. When using one light-emitting element and one light-receiving element in this manner, a detection voltage that crosses a threshold is generated due to an environmental change that occurs during scanning of a print medium, such as floating of an edge of the medium or ambient light. For this reason, the influence of an environmental change cannot be reduced, and a medium edge portion cannot be accurately detected.

In addition, in Japanese Patent Publication No. 6630121, displacement of an aperture stop is absorbed and displacement of specular reflected light is corrected, but there has been an issue that the specular reflected light, which is sensitive to the reflection angle, is greatly affected by a change in light amount caused by a floating condition of a paper or the like, and thus it is difficult to accurately detect an edge of paper.

### SUMMARY

Embodiments of the present disclosure eliminate the above-mentioned issues with conventional technology.

A feature of embodiments of the present disclosure is to provide a technique of reducing the influence of an environmental change and accurately detecting a medium edge portion.

According to embodiments of the present disclosure, there is provided a printing apparatus comprising: a sensor unit including a light emitter configured to emit light toward a detection target, a light-receiving element array including a plurality of light-receiving elements configured to receive reflected light from the detection target, and an aperture member, provided between the detection target and the light-receiving element array, having an opening portion for regulating the reflected light; and one or more controllers including one or more processors and one or more memories, the one or more controllers configured to: cause the sensor unit to scan over the detection target, select, from the light-receiving element array, different light-receiving elements as a first light-receiving unit and a second light-receiving unit to be used for detecting an edge of a print medium included in the detection target, detect the edge of the print medium based on a differential signal obtained by performing differential amplification on signals from the first light-receiving unit and the second light-receiving unit, and obtain a positional relation between each of the light-receiving elements of the light-receiving element array and the opening portion of the aperture member through which the reflected light passes, wherein, in the selection of light-receiving elements, the one or more controllers select one or more light-receiving elements to be used as each of the first light-receiving unit and the second light-receiving unit, based on the obtained positional relation.

Further features of the various embodiments will become apparent from the following description of exemplary embodiments with reference to the attached drawings. The following descriptions of embodiments are described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a block diagram for describing a configuration of an inkjet printing apparatus according to an embodiment of the present disclosure.

FIG. 2 is a schematic diagram for describing a mechanism of a carriage in which a print head of the inkjet printing apparatus according to the embodiment is mounted, as viewed from above.

FIG. 3 is a conceptual diagram for describing operations of a sensor unit according to the embodiment.

FIG. 4 is a diagram for describing, in detail, operations of the sensor unit when detecting an edge portion of a sheet.

FIGS. 5A and 5B are diagrams for describing the relationship between the position of a light-receiving aperture and the positions of light-receiving elements in a light-receiving element array.

FIGS. 6A to 6C are diagrams for describing processing for determining optimal positions of light-receiving elements in the light-receiving element array with respect to the light-receiving aperture.

FIG. 7 is a diagram showing an example of connection between the light-receiving element array, a selector, and a differential amplifier in the sensor unit according to the embodiment.

FIG. 8 is a flowchart for describing processing for obtaining distribution such as that shown in FIG. 6B and obtaining a light-receiving element located close to the light-receiving aperture, in the printing apparatus according to the embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

First, terms that are used in the present embodiment are defined in advance as follows.

### Recording

In this specification, the term “recording” is not limited to cases of forming meaningful information such as characters and graphics. This term is used regardless of whether the information is meaningful or meaningless and regardless of whether or not the information is visibly perceptible to human eyes. The term also broadly represents cases where an image, texture, a pattern, or the like is formed on a print medium, and where a medium is processed.

### Print Medium

The term “print medium” refers not only to paper used in general printing apparatuses, but also broadly encompasses materials capable of receiving ink, such as fabric, plastic films, metal plates, glass, ceramics, wood, and leather.

### Ink

The term “ink” is to be broadly interpreted in the same manner as the above definition of “recording”, and refers to a medium that may be a recording material which, when applied onto a print medium, can be used to form an image, texture, a pattern, or the like, to process a print medium, or to perform ink processing. Ink is liquid as a physical property thereof. The above phrase “ink processing” refers to coagulation or insolubilization of a colorant contained in ink applied to a print medium, for example.

### Nozzle

Unless otherwise specified, the term “nozzle” refers to a discharge outlet. Inside a nozzle, there is a communicating liquid channel and an element that generates energy used for discharging ink.

### Scanning

In order to perform recording on a print medium, a recording head scans over the print medium. Here, movement of a head to perform recording or movement of a head while accelerating or decelerating the head in association with recording is referred to as scanning.

### Reciprocal Recording

The term “reciprocal recording” refers to the above “recording” or “scanning” performed while reciprocally moving a recording head over the surface of paper. The terms “reciprocal scanning,” “reciprocal recording”, “bidirectional scanning,” and “bidirectional recording” also refer to the same operation.

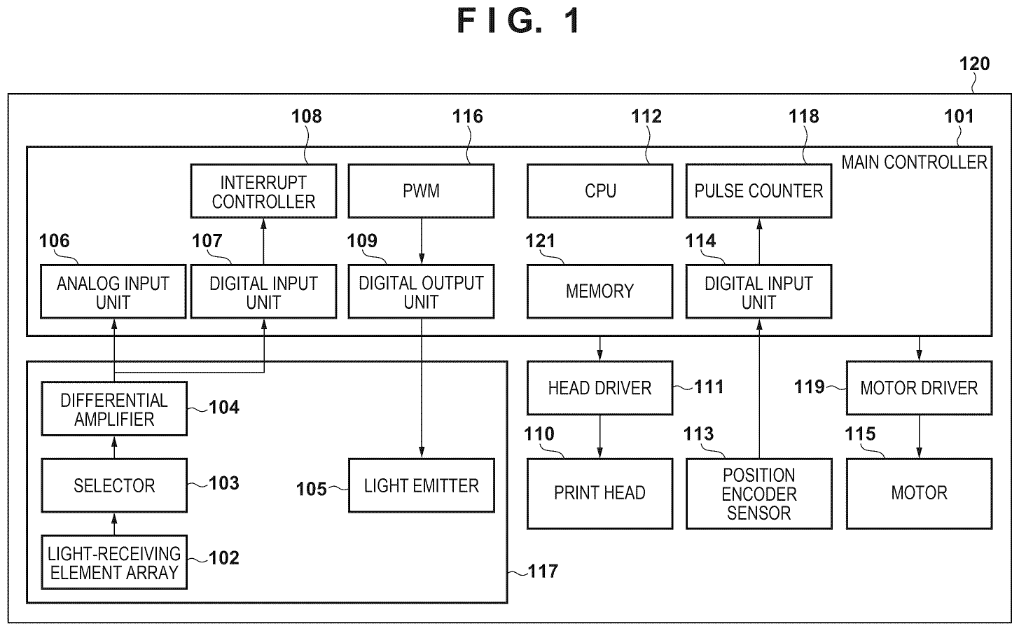

FIG. 1 is a block diagram for describing a configuration of an inkjet printing apparatus 120 according to an embodiment of the present disclosure.

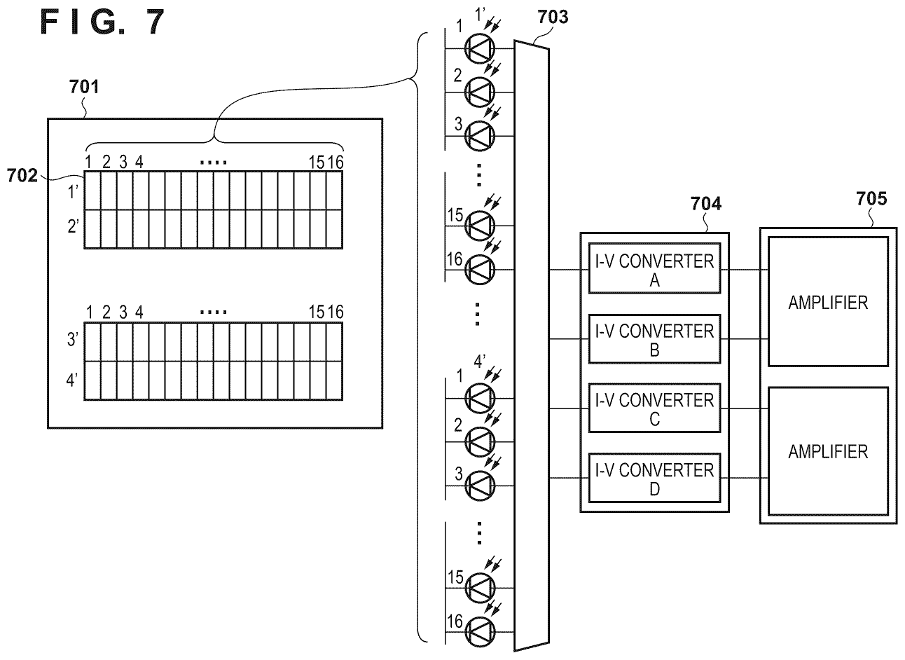

A sensor unit 117 includes a light emitter 105 and a light-receiving element array 102, and signals that are output from the light-receiving element array 102 are output to a differential amplifier (differential amplification unit) 104 via a selector 103. The differential amplifier 104 is capable of amplifying or differentially amplifying signals from selected light-receiving elements (light-receiving sensors) in the light-receiving element array 102, based on the settings of the selector 103, and outputs an amplified signal to a main controller 101. Note that a circuit example of this sensor unit 117 will be described later with reference to FIG. 7. The main controller 101 receives the signal from the differential amplifier 104 using an analog input unit 106 and a digital input unit 107. In addition, an output of the digital input unit 107 is connected to an interrupt controller 108 in the main controller 101, and the interrupt controller 108 issues an interrupt signal to a CPU 112 in accordance with a predetermined interrupt condition, such as the output of the digital input unit 107. The CPU 112 controls operations of this inkjet printing apparatus 120 in accordance with a program stored in a memory 121. This memory 121 includes a ROM and a RAM (both not illustrated). Upon receiving the interrupt signal, the CPU 112 executes processing of the interrupt signal with higher priority than processing that is currently executed, and thus can more immediately handle a signal input to the digital input unit 107. In addition, the light emitter 105 is driven by a pulse-width modulation signal output from a PWM (pulse width modulation) unit 116 in the main controller 101 via a digital output unit 109, and the light emission amount of the light emitter 105 is controlled through pulse width modulation.

A print head 110 is driven via a head driver 111 in accordance with image signals to be recorded. In addition, the print head 110 scans over a print medium by being driven by a motor 115 driven via a motor driver 119. The motor is also driven via the motor driver 119 by the main controller 101 to convey a print medium. The scanning position of the print head 110 is detected based on a signal input from a position encoder sensor 113 to a digital input unit 114, and is managed by a pulse counter 118 in the main controller 101.

FIG. 7 is a diagram showing an example of connection between a light-receiving element array, a selector, and a differential amplifier of the sensor unit 117 according to the embodiment.

A light-receiving element array 701, which corresponds to the light-receiving element array 102 and is constituted by a plurality of sensors (light-receiving elements 702), is disposed in the sensor unit 117. FIG. 7 shows a sensor unit that includes a total of 64 sensors arranged as four rows of sixteen light-receiving elements 702. The light-receiving elements 702 are connected to a selector 703, in the sensor unit 117. This selector 703 corresponds to the selector 103 in FIG. 1. Based on the settings of this selector 703, light-receiving elements 702 to be used for detecting a medium edge portion can be suitably selected from the light-receiving element array 701. Also, outputs from a plurality of light-receiving elements 702 can be combined and output based on the settings of the selector 703, and it is possible to suitably select both the number of light-receiving elements 702 to be combined and the positions thereof. For example, outputs from sixteen light-receiving elements, namely the first to sixteenth light-receiving elements in the third row can be combined as a light-receiving unit and connected to the selector 703, or it is also possible to select, as a light-receiving unit, output from odd-numbered light-receiving elements, such as the first, third, fifth, and seventh light-receiving elements in the first row. Furthermore, any number of light-receiving elements at any positions can be selected to obtain a light-receiving unit, and, for example, output from the first light-receiving elements 702 in 1′ to 4′ rows can be selected as a light-receiving unit. If a plurality of light-receiving elements 702 that are combined can be selected as a light-receiving unit in this manner, the surface area of light-receiving units can be virtually increased, and thus it is possible to realize improvement in the sensitivity of the light-receiving unit and the like. Such settings of the selector 703 can be switched in accordance with an instruction from the CPU 112, and selection, arrangement, and the like of light-receiving elements, which will be described later, are carried out through cooperation between the CPU 112 and the selector 103.

Output of the selector 703 is connected to I-V converters A to D disposed in an I-V conversion unit 704 in the sensor unit 117. Accordingly, it is possible to suitably select, using the selector 703, which I-V converter the output of a single light-receiving element 702 or a group of multiple light-receiving elements 702 is connected to. Outputs of the I-V conversion unit 704 are connected to an amplification unit 705, and amplified output can be obtained from the amplification unit 705. This amplification unit 705 corresponds to the differential amplifier 104 in FIG. 1. The amplification unit 705 includes a coarse adjustment amplifier, a fine adjustment amplifier, a differential amplifier, and the like, and it is possible to suitably select which amplifier to use, and it is also possible to suitably select a combination of amplifiers. However, the configuration of the amplification unit 705 is not limited only to the above case where a plurality of amplifiers are disposed in the amplification unit 705, and, for example, a single type or a larger number of different types of amplifiers may be disposed.

In addition, in FIG. 7, the selector 703, the I-V conversion unit 704, and the amplification unit 705 are incorporated in the sensor unit 117. However, a configuration may also be adopted in which the sensor unit 117 includes only the light-receiving element array 701, and the selector 703, the I-V conversion unit 704, and the amplification unit 705 are provided as external circuits. As a combination example for detecting a medium edge portion, for example, outputs from the first light-receiving elements 702 in the 1′row and output from the first light-receiving element 702 in the 2′row of the light-receiving element array 701 are selected by the selector 703, and are connected to the I-V converter A and I-V converter B of the I-V conversion unit 704, respectively. The outputs from these first light-receiving elements 702 are then input to the differential amplifier of the amplification unit 705, and output obtained from the amplification unit 705 can be used to perform an operation of detecting a medium edge portion, which will be described later. If the number of light-receiving elements 702 and the positions thereof used for detecting a medium edge portion can be suitably selected in this manner, it is possible to perform processing for detecting a medium edge portion in various cases that are envisioned.

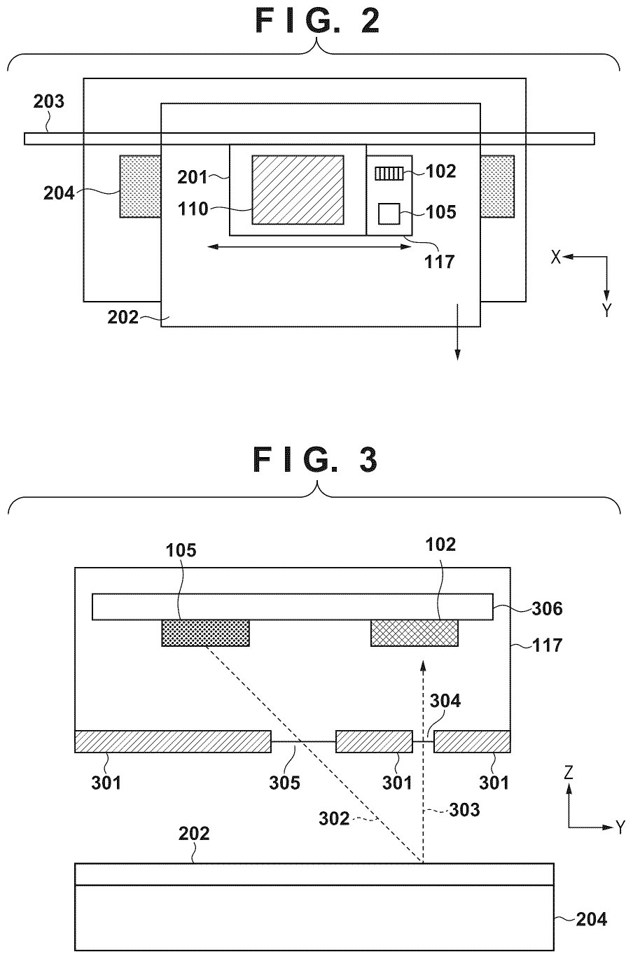

FIG. 2 is a schematic diagram for describing a mechanism of a carriage 201 in which the print head 110 of the inkjet printing apparatus 120 according to the embodiment is mounted, as viewed from above.

The print head 110 is mounted on the carriage 201, and the carriage 201 is supported to be capable of reciprocal scanning along a main rail 203. The sensor unit 117 is also mounted on the carriage 201, and is capable of reciprocal scanning likewise. Accordingly, the sensor unit 117 is capable of scanning in the width direction (X direction) of a sheet 202, and the main controller 101 can perform an operation of detecting a medium edge portion based on reflected light from the sheet 202, a platen 204, and the like. The sheet 202 is supported on the platen 204. The light-receiving element array 102 (the light-receiving element array 701 in FIG. 7) of the sensor unit 117 is disposed parallel to the scanning direction (X direction) of the carriage 201. The light emitter 105 is disposed at a position offset in a direction perpendicular to the light-receiving element array 102 (Y direction). Such an arrangement makes it possible to reduce the width of the carriage 201, including the sensor unit 117.

FIG. 3 is a conceptual diagram for describing operations of the sensor unit 117 according to the embodiment.

FIG. 3 is a diagram of the sensor unit 117 as viewed laterally (in the X direction in FIG. 2), in which the light-receiving elements of the light-receiving element array 102 are aligned in the depth direction (X direction) of the figure. The light emitter 105 and the light-receiving element array 102 on a substrate 306 oppose the sheet 202 or the platen 204 via an aperture member 301 of the sensor unit 117. Light emitted from the light emitter 105 passes through a projection aperture 305 to form a light beam 302, which is projected onto the sheet 202. The projected light beam 302 is reflected by the sheet 202, and a part of the reflected light passes through the light-receiving aperture (opening portion) 304 to form a light beam 303, which is received by the light-receiving element array 102. At this time, diffuse reflection from the sheet 202 is used for the light beam 303, and a reflection component that has low dependency on an angle of reflection is used.

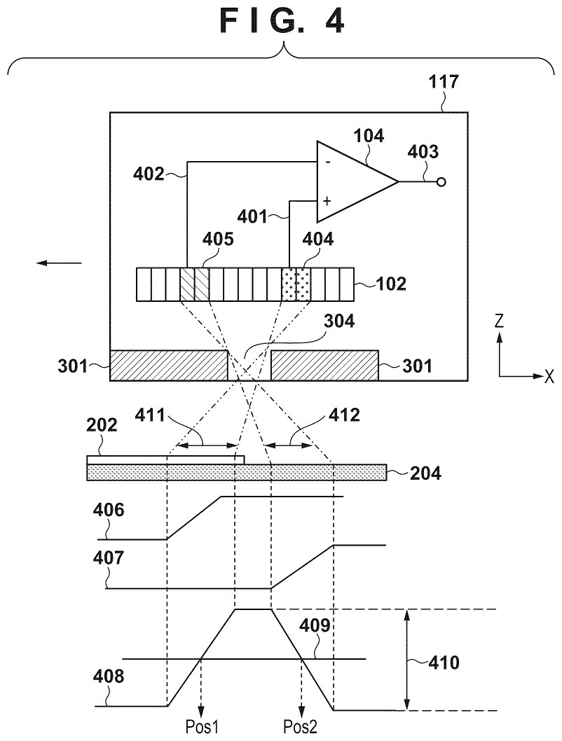

FIG. 4 is a diagram for describing detailed operations of the sensor unit 117 when processing when detecting an edge portion of the sheet 202 is performed.

Outputs of light-receiving elements 404 and 405 from among the light-receiving elements of the light-receiving element array 102 are selected by the selector 103 and connected to the differential amplifier 104. Here, a signal 401 output from the light-receiving element 404 and a signal 402 output from the light-receiving element 405 are input to the differential amplifier 104. Here, the signal 401 is input to the non-inverting input terminal (+) of the differential amplifier 104, while the signal 402 is input to the inverting input terminal (−) of the differential amplifier 104. Accordingly, the differential amplifier 104 outputs a differential signal 403 based on the difference between the signals 401 and 402 that have been input thereto.

Although not shown in FIG. 4, the light emitter 105 emits light toward the sheet 202 through the projection aperture 305 (FIG. 3) of the aperture member 301, from either the front side or the rear side in FIG. 4. The light-receiving elements 404 and 405 respectively detect reflected light from the sheet 202 through the light-receiving aperture 304 of the aperture member 301. The light-receiving elements 404 and 405 each have an angle with respect to the light-receiving aperture 304, and thus the light-receiving element 404 assumes a region 411 on the sheet 202 as a detection region, and the light-receiving element 405 assumes a region 412 as a detection region. Note that the surface of the platen 204 has been processed to be substantially non-reflective.

Next, it is assumed that, here, regarding movement of signals, the carriage 201 and the sensor unit 117 move in the leftward direction (arrow direction) from the right side in the figure. When the sensor unit 117 moves to a position above an edge of the sheet 202, the detection region 411 reaches the sheet 202 first, and thus the light-receiving element 404 detects reflected light from the sheet 202 first, whereby the level of the signal 401 output from the light-receiving element 404 rises, and is input to the non-inverting input terminal (+) of the differential amplifier 104. A detection waveform 406 illustrates changes of the signal 401 over time.

Here, with a focus on the detection region 411 that is detected by the light-receiving element 404, when the sensor unit 117 is positioned further to the right than the position thereof shown in FIG. 4, the detection region 411 is located on the platen 204, which has low reflectance. For this reason, the amount of reflected light that enters the light-receiving element 404 is small, and the signal level is at a low level as indicated by the detection waveform 406. Next, when the sensor unit 117 moves in the leftward direction (arrow direction) in FIG. 4, the detection region 411 detects the sheet 202 having high reflectance as shown in FIG. 4, and the signal level gradually transitions to a higher level as indicated in the detection waveform 406 according to the movement of the sensor unit 117. At this time, the detection region 412 for the light-receiving element 405 is still on the platen 204, and thus the level of the signal 402 output from the light-receiving element 405 remains low. In this manner, a level difference arises between the signal 401 and the signal 402, and the differential signal 403 output from the differential amplifier 104 transitions to a higher level as shown a differential waveform 408, as the detection region 411 on the sheet 202 increases in size while the detection region 412 is on the platen 204.

When the carriage 201 further moves in the arrow direction from here, the sheet 202 reaches the detection region 412 for the light-receiving element 405, and thus the sheet 202 starts to be detected. Accordingly, the signal 402 output from the light-receiving element 405 also gradually transitions to a high level as indicated by detection waveform 407 in accordance with the movement of the sensor unit 117. When the level of the signal 402 rises in this manner, the difference from the level of the signal 401 that is already high decreases, and the level of the differential signal 403 output from the differential amplifier 104 starts to decrease. In this manner, the differential signal 403 takes a waveform such as that indicated by the differential waveform 408, and a detection signal that is pulsed in the vicinity of the edge of the sheet 202 is obtained.

The timings of the rising and falling edges of this pulsed detection signal are obtained based on a threshold 409. That is to say, the scanning positions (positional coordinates) of the carriage 201 at the timings when the detection signal rises to a level higher than or equal to the threshold and falls to a level lower than or equal to the threshold are obtained, and are defined as Pos1 and Pos2, respectively. By obtaining the central coordinates of the positional coordinates of Pos1 and Pos2, it is possible to obtain an edge portion of the sheet 202 that is located at the positional center between the light-receiving elements 404 and 405. Note that this edge portion is not limited to the central coordinates between Pos1 and Pos2, and may be obtained as a position that is based on a preset ratio, and, for example, a position obtained by dividing the distance between Pos1 and Pos2 in the ratio of 6 to 4, for example, may be adopted.

An advantage of the embodiment is that, by detecting an edge of a sheet based on a differential signal obtained from the difference between two signals in this manner, it is possible to cancel out the influence of disturbance that is commonly received by the light-receiving elements 404 and 405, and stable detection of a medium edge portion is enabled.

In order to achieve advantages of detection of an edge portion using a differential signal, there is a need to ensure, in terms of optics and circuitry, symmetry between signals from which a differential is obtained, and to avoid redundancy between the signals from which a differential is obtained. If there is no symmetry, timings of signal levels of the signals 401 and 402 respectively output from the light-receiving elements 404 and 405 are misaligned, and when the differential amplifier 104 obtains a differential, the amount of misalignment remains without being offset. As a result, an amplitude 410 of the differential waveform 408 output from the differential amplifier 104 decreases or causes signal offset, and the signal-to-noise ratio of the differential signal decreases. In addition, if there is redundancy between signals from which a differential is to be obtained, the redundant portion is also offset when the differential amplifier 104 obtains a differential, and the signal intensity of the original detection waveforms 406 and 407 decreases. Consequently, after all, a problem occurs such as a decrease in the amplitude 410 of a differential signal.

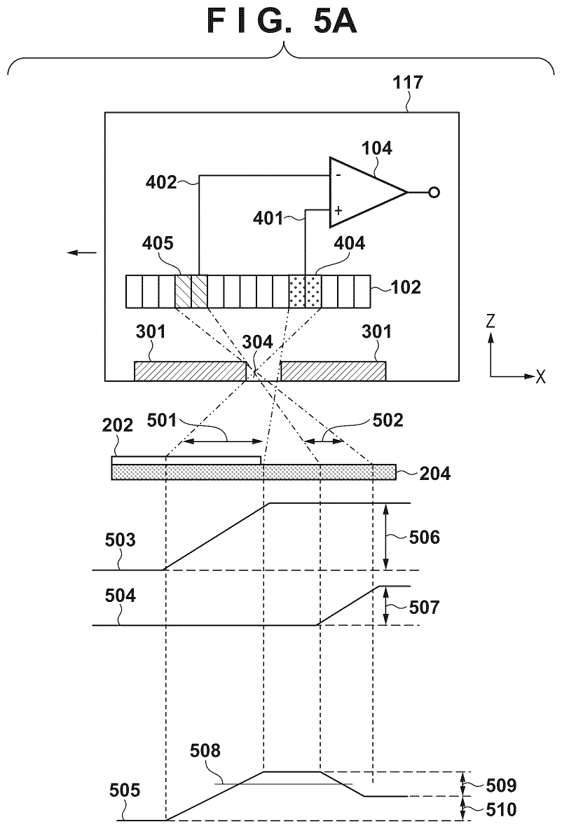

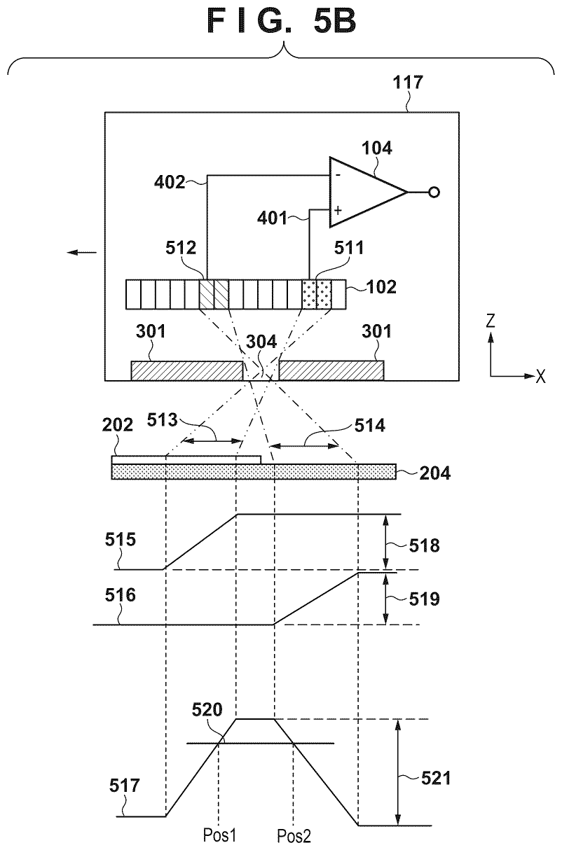

FIGS. 5A and 5B are diagrams for describing the relationship between the position of the light-receiving aperture 304 and the position of light-receiving elements of the light-receiving element array 102.

FIG. 5A is a diagram showing operations when the light-receiving aperture 304 and light-receiving elements of the light-receiving element array 102 are displaced relative to each other. Here, the light-receiving aperture 304 is disposed at a position close to the light-receiving element 404 and distant from the light-receiving element 405. At this time, a detection region 501 assumed by the light-receiving element 404 through the light-receiving aperture 304 is larger than the detection region 411 shown in FIG. 4 since the light-receiving element 404 is closer to the light-receiving aperture 304. For this reason, the amount of reflected light that is input to the light-receiving element 404 increases, and the signal level of a detection waveform 503 of the signal 401 output from the light-receiving element 404 rises as indicated by reference numeral 506.

On the other hand, since the light-receiving element 405 is distant from the light-receiving aperture 304, a detection region 502 assumed by the light-receiving element 405 through the light-receiving aperture 304 is smaller, and the amount of reflected light that is obtained is also smaller. For this reason, the amplitude of the detection waveform 504 of the signal 402 output from the light-receiving element 405 is smaller as indicated by reference numeral 507.

Therefore, a differential signal that is output from the differential amplifier 104 that takes a differential between these signals 401 and 402 has a differential waveform 505. Here, the amplitudes of the signal levels of the signals 401 and 402 differ as indicated by the above reference numerals 506 and 507, and thus, taking a differential between the signals 401 and 402 does not result in a completely zero differential signal, and results in an offset component 510 instead. Accordingly, the amplitude of the differential waveform 505 is formed as indicated by reference numeral 509, in a compressed form due to the offset component 510. A threshold 508 for obtaining the timings of the rising and falling edges of the pulsed differential signal needs be set within the amplitude 509, which reduces the margin of the amplitude.

FIG. 5B is a diagram showing operations when the positions of the light-receiving elements 404 and 405 in the light-receiving element array 102 in FIG. 5A are changed to the positions indicated by light-receiving elements 511 and 512.

The light-receiving element 512 is disposed at a position closer to the light-receiving aperture 304 than the light-receiving element 405 is, and a detection region 514 is assumed by the light-receiving element 512 through the light-receiving aperture 304. In addition, the light-receiving element 511 is disposed relative to the light-receiving element 512 to maintain the positional relation between the light-receiving elements 404 and 405, and a detection region 513 is assumed by the light-receiving element 511 through the light-receiving aperture 304, and here, the light-receiving element 511 and the light-receiving element 512 are disposed with a space corresponding to five elements therebetween. With such a configuration, arrangement is realized in which the light-receiving element 511 is positioned more distant from the light-receiving aperture 304 than the light-receiving element 404, and the signal 401 output from the light-receiving element 511 has a form as indicated by a detection waveform 515. An amplitude 518 of this detection waveform 515 is smaller than the amplitude 506 of the detection waveform 503 in FIG. 5A.

On the other hand, the light-receiving element 512 is closer to the light-receiving aperture 304, and thus the signal 402 that is output by the light-receiving element 512 has a form as indicated by a detection waveform 516, whose amplitude 519 is larger than the amplitude 507 in FIG. 5A. In this manner, the amplitudes 518 and 519 are closer to each other. For this reason, a differential signal that is output by the differential amplifier 104 that takes a differential between the detection waveforms 515 and 516 has a form as indicated by a differential waveform 517. That is to say, the difference in amplitude when the signals 401 and 402 reach the highest level decreases, and the offset of the differential signal is reduced. As a result, a large amplitude 521 can be obtained as indicated by the differential waveform 517 of the differential signal, and it is also possible to improve the margin of the amplitude for a threshold 520.

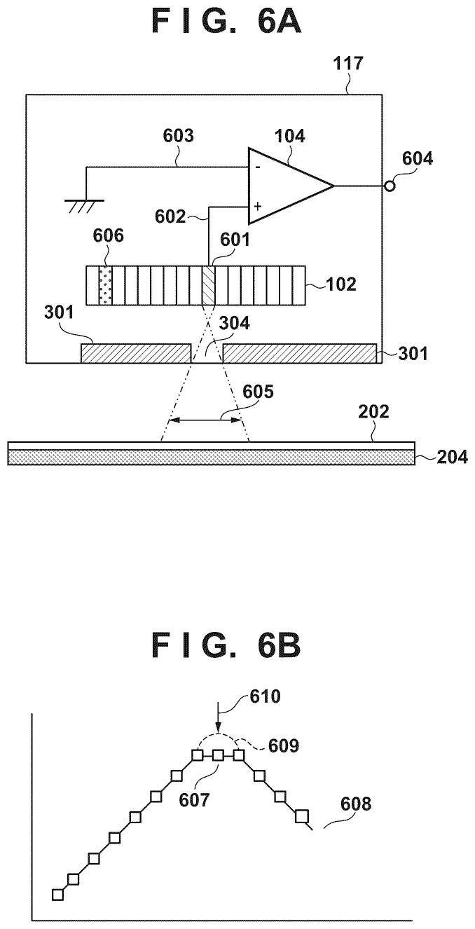

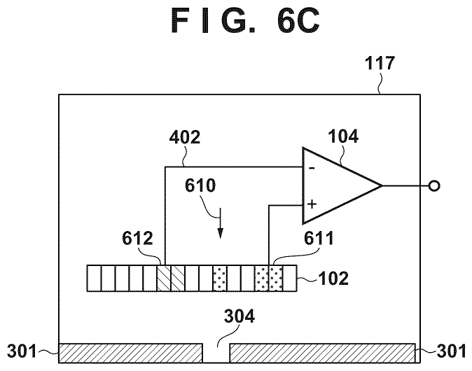

Next, an inspection method for achieving balanced settings between the light-receiving elements 511 and 512 as shown in FIG. 5B will be described with reference to FIG. 6A to 6C.

FIGS. 6A to 6C are diagrams for describing processing for obtaining the optimum position of a light-receiving element of the light-receiving element array 102 relative to the light-receiving aperture 304.

As described above, the sensor unit 117 scans over the sheet 202 and detects a medium edge portion. FIG. 6A is a diagram in which each signal output by the light-receiving element of the light-receiving element array 102 is sequentially selected one by one from one end by the selector 103, and the intensity of the reflected light from the sheet 202 detected by each light-receiving element is obtained. At this time, a detection signal 602 from a light-receiving element 601 is connected to the non-inverting input terminal of the differential amplifier 104, and the inverting input terminal (−) of the differential amplifier 104 is connected to GND via a line 603. Accordingly, the differential amplifier 104 operates as an amplifier. The differential amplifier 104 that operates as the amplifier outputs an amplified signal 604 obtained through amplification, and inputs the amplified signal 604 to the analog input unit 106 of the main controller 101. The CPU 112 then converts this signal input to the analog input unit 106 into a digital signal, and can thereby obtain the intensity of reflected light that is based on the detection signal 602, using the digital signal obtained through conversion.

Since the light-receiving element 601 is located close to the light-receiving aperture 304, it is possible to obtain a larger detection region 605 and a detection signal 602 with a higher signal level. An operation of obtaining the detection signal 602 and the amplified signal 604 is performed on each of the light-receiving elements of the light-receiving element array 102. For example, a light-receiving element 606, which is a second light-receiving element from the left in FIG. 6A, is distant from the light-receiving aperture 304, and thus a smaller amount of reflected light is obtained and the detection signal 602 with a lower signal level is obtained.

FIG. 6B shows, as distribution of selected light-receiving elements, the amplified signal 604 that is based on the detection signal 602 obtained by sequentially selecting a light-receiving element of the light-receiving element array 102 as described above. In FIG. 6B, the horizontal axis indicates number of selected light-receiving element in the light-receiving element array 102, and the vertical axis indicates signal level of the amplified signal 604. This distribution is formed in a curved shape, with a high-signal level region 607 in the vicinity of the peak. The distribution has the property that, as the position of a selected light-receiving element in the light-receiving element array 102 moves toward an end portion from the high-signal level region 607, the level of a detection signal from the light-receiving element decreases. In the high-signal level region 607, there is a positional relation in which a selected light-receiving element is close to the light-receiving aperture 304, and thus the level of the amplified signal 604 corresponding to the resultant detection signal is high. Note that, here, the size of each light-receiving element is smaller than the light-receiving aperture 304, and thus, in this FIG. 6B, the levels of detection signals from about three light-receiving elements are high and are similar. For this reason, distribution 608 formed in a trapezoidal shape (indicated by the solid line) is obtained.

As described with reference to FIG. 3, a light beam 303 entering light-receiving element through the light-receiving aperture 304 utilizes diffuse reflection and therefore has low dependence on a reflection angle, and thus, distribution is obtained in which a light-receiving element located directly above the light-receiving aperture 304 outputs a more intense signal than other light-receiving elements.

Curve fitting 609 (dashed line) is applied to the distribution 608 to calculate a central position 610. Here, in FIG. 6A, assume that the maximum value is obtained from the tenth light-receiving element from the left in the light-receiving element array 102. By obtaining such distribution in this manner, it is possible to obtain the positional relation between the light-receiving aperture 304 and each light-receiving element of the light-receiving element array 102.

FIG. 6C shows the positional relation between the light-receiving aperture 304 and light-receiving elements of the light-receiving element array 102 based on the distribution obtained in this manner.

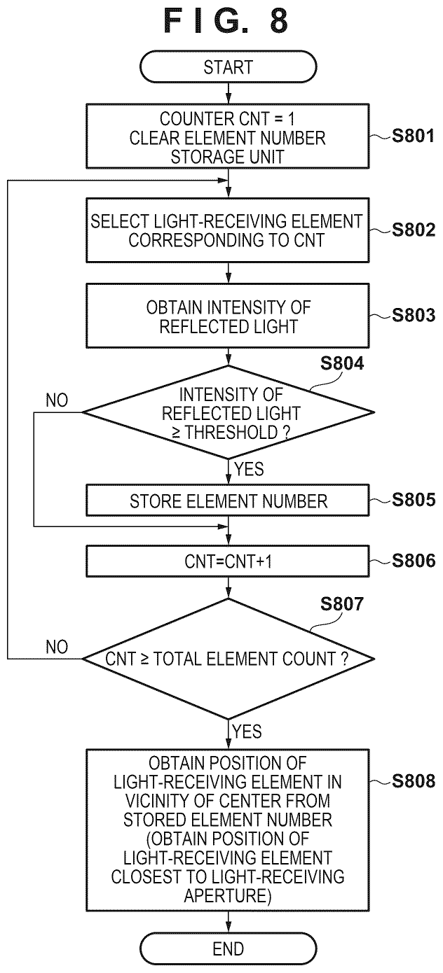

FIG. 8 is a flowchart for describing processing for obtaining distribution such as that shown in FIG. 6B and obtaining a light-receiving element located close to the light-receiving aperture 304, in the printing apparatus according to the embodiment. Note that the processing shown in this flowchart is achieved by the CPU 112 executing a program stored in the memory 121. In addition, at this time, the sensor unit 117 has wiring such as that shown in FIG. 6A.

First, in step S801, the CPU 112 sets, to 1, CNT that is an index indicating the position of a light-receiving element, and resets, to 0, a storage unit that stores the position of a light-receiving element that outputs a signal whose intensity of is higher than or equal to a predetermined value (is close to the light-receiving aperture 304). Note that the CNT and the storage unit are provided in the RAM of the memory 121. Next, the processing advances to step S802, where the CPU 112 selects the first light-receiving element (on the left side in the example in FIG. 6A) corresponding to the value of CNT of the light-receiving element array 102, based on the settings of the selector 103. The processing then advances to step S803, where the CPU 112 inputs, via the analog input unit 106, output of the differential amplifier 104 when the light emitter 105 emits light. The CPU 112 then obtains the intensity of reflected light detected by the selected light-receiving element based on the voltage value of the output of the differential amplifier 104. The processing then advances to step S804, where the CPU 112 determines whether or not the intensity of the reflected light is higher than or equal to a threshold. If the intensity is not higher than or equal to the threshold, the processing advances to step S806, where the CPU 112 adds 1 to CNT, and advances the processing to step S807. On the other hand, if the intensity of the reflected light is higher than or equal to the threshold, the processing advances to step S805, where the CPU 112 stores, in the above storage unit, the value of CNT at this time, that is to say, the number of the light-receiving element, and advances the processing to step S806. Note that this threshold is a signal level corresponding to the high-signal level region 607 in FIG. 6B. In step S807, the CPU 112 determines whether or not the CNT value has reached the total number of light-receiving elements of the light-receiving element array 102, and if the total number of light-receiving elements is not reached, the processing advances to step S802. Note that there is no need to determine whether or not intensity has been obtained for all of the light-receiving elements in step S807, and a configuration may be adopted in which, after the intensity of reflected light has exceeded the threshold, determination is performed whether or not the intensity has reached the threshold or lower, and when the intensity reaches the threshold or lower, the processing advances to step S808. When detection of the intensity of reflected light is complete for all of the light-receiving elements of the light-receiving element array 102 in this manner, the processing advances to step S808, where the CPU 112 obtains a light-receiving element corresponding to the median value of the numbers of the light-receiving elements stored in the storage unit. That is to say, the CPU 112 obtains a light-receiving element positioned substantially directly above the light-receiving aperture 304. Note that, if the number of numbers assigned to the light-receiving elements stored in the storage unit is an odd number, the number of the central light-receiving element is uniquely obtained. On the other hand, if the number of numbers assigned to the light-receiving element stored in the storage unit is an even number, one of the two light-receiving elements close to the center may be determined as a light-receiving element positioned substantially directly above the light-receiving aperture 304.

Distribution such as that shown in FIG. 6B is obtained in this manner, and, based on this, it is possible to obtain the light-receiving element positioned substantially directly above the light-receiving aperture 304 (corresponding to the central position 610 in FIG. 6C).

A description will be given based on a specific example in FIG. 6C. The center of the light-receiving elements to be used for obtaining a differential is set to be, for example, the tenth light-receiving element, which is the closest light-receiving element to the calculated central position 610. That is to say, the sixth and seventh light-receiving elements are set as light-receiving elements 612 that are to be used for obtaining a differential and are located on one side. The 13th and 14th light-receiving elements are set as light-receiving elements 611 that are located on the other side and are symmetrical with the light-receiving elements 612 with respect to the central position 610 (the tenth light-receiving element). In this manner, the light-receiving elements 611 are disposed such that there are two elements between the tenth light-receiving element, which is the closest to the central position 610, and the light-receiving elements 611. Note that, except for an operation of determining the center of the light-receiving elements 611 and 612 to be used for obtaining a differential signal in this manner, operations of the light-receiving elements 611 and 612 are the same as those of the light-receiving elements 404 and 405 in FIG. 4. Accordingly, the explanation of the operations of the light-receiving elements 611 and 612 is omitted.

As described above, according to the embodiment, by aligning the center of the light-receiving elements 611 and 612 to be used for detecting a medium edge portion based on a differential signal, relative to the light-receiving aperture 304, it is possible to suppress the influence on the amplitude of the differential signal, the detection regions 411 and 412, and the like, which are other properties. It is possible to reduce individual differences in the properties of the sensor unit 117 in this manner.

In addition, appropriately setting light-receiving elements to be used for detecting a medium edge portion with respect to a light-receiving aperture provides an effect of making it possible to reduce error in detection results caused by deviation of the optical axis of reflected light that passes through the light-receiving aperture and reaches light-receiving elements.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-143350, which was filed on Aug. 23, 2024, and which is hereby incorporated by reference herein in its entirety.

What is claimed is:

1. A printing apparatus comprising:
a sensor unit including a light emitter configured to emit light toward a detection target, a light-receiving element array including a plurality of light-receiving elements configured to receive reflected light from the detection target, and an aperture member, provided between the detection target and the light-receiving element array, having an opening portion for regulating the reflected light; and
one or more controllers including one or more processors and one or more memories, the one or more controllers configured to:
cause the sensor unit to scan over the detection target,
select, from the light-receiving element array, different light-receiving elements as a first light-receiving unit and a second light-receiving unit to be used for detecting an edge of a print medium included in the detection target,
detect the edge of the print medium based on a differential signal obtained by performing differential amplification on signals from the first light-receiving unit and the second light-receiving unit, and
obtain a positional relation between each of the light-receiving elements of the light-receiving element array and the opening portion of the aperture member through which the reflected light passes,
wherein, in the selection of light-receiving elements, the one or more controllers select one or more light-receiving elements to be used as each of the first light-receiving unit and the second light-receiving unit, based on the obtained positional relation.

2. The printing apparatus according to claim 1, wherein, in the obtaining of the positional relation, the one or more controllers obtain a position of a light-receiving element at a closest position to the opening portion of the aperture member through which the reflected light passes, and
wherein, in the selection of light-receiving elements, the one or more controllers select one or more light-receiving elements such that the first light-receiving unit and the second light-receiving unit are disposed on opposite sides of the light-receiving element at the closest position to the opening portion.

3. The printing apparatus according to claim 2, wherein, in the selection of light-receiving elements, the one or more controllers select one or more light-receiving elements such that the first light-receiving unit and the second light-receiving unit are positioned symmetrically centered about the light-receiving element at the closest position to the opening portion.

4. The printing apparatus according to claim 1, wherein, in the obtaining of the positional relation, the one or more controllers sequentially select a light-receiving element of the light-receiving element array, obtain an intensity of a signal output from the selected light-receiving element, and obtain a position of a light-receiving element for which the intensity is highest as a position of a light-receiving element positioned above the opening portion.

5. The printing apparatus according to claim 4, wherein, in the obtaining of the positional relation, in a case where there are one or more light-receiving elements for which the intensity is highest, the one or more controllers obtain a position of a light-receiving element positioned at substantially a center of the one or more light-receiving elements as the light-receiving element positioned above the opening portion.

6. The printing apparatus according to claim 1, further comprising:
an amplifier configured to receive a signal from each of the plurality of light-receiving elements of the light-receiving element array and output an amplified signal,
wherein, in the obtaining of the positional relation, the one or more controllers obtain a distribution of the amplified signals output from the amplifier, and obtain the positional relation between each of the light-receiving elements of the light-receiving element array and the opening portion of the aperture member based on the distribution.

7. The printing apparatus according to claim 6, wherein, in the selection of light-receiving elements, the one or more controllers select one or more light-receiving elements that are closest to the opening portion of the aperture member and are to be used as each of the first light-receiving unit and the second light-receiving unit, based on the obtained positional relation.

8. The printing apparatus according to claim 1, further comprising:
a differential amplifier configured to output a differential signal between a first signal output from the first light-receiving unit and a second signal output from the second light-receiving unit,
wherein the one or more controllers further obtain a scanning position of the sensor unit that performs scanning, and
wherein, in the detection of the edge of the print medium, the one or more controllers detect, in the scanning by the sensor unit, the edge of the print medium based on first coordinates indicating the scanning position obtained when the differential signal rises to a threshold or higher and second coordinates indicating the scanning position obtained when the differential signal falls to the threshold or lower.

9. The printing apparatus according to claim 8, wherein, in the detection of the edge of the print medium, the one or more controllers detect central coordinates between the first coordinates and the second coordinates, as the edge of the print medium.

10. The printing apparatus according to claim 1, wherein the detection target includes at least one of the print medium and a platen that supports the print medium.

11. The printing apparatus according to claim 1, wherein the light-emitting portion emits light toward the detection target via an opening portion different from the opening portion of the aperture member.
